(19) United States
(12) Patent Application Publication
(10) Pub. No.: US 2003/0058471 A1
(43) Pub. Date: Mar. 27, 2003

(54) Method and apparatus for image processing capable of automatically adding/upgrading image processing functions, and a computer readable data medium containing computer instructions for performing the method

(76) Inventor: Hiromi Okubo, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/251,798

(22) Filed: Sep. 23, 2002

(30) Foreign Application Priority Data
Sep. 21, 2001 (JP) 2001-290016

(51) Int. Cl. B41B 1/00; G06F 15/00

(52) U.S. Cl. 358/1.16

(57) ABSTRACT

An image processing apparatus having individual image processing programs, the apparatus includes mechanisms of image processing, function enhancement, and enhancement control. The image processing mechanism having hardware resources performing individual image processing operations in collaboration with the individual image processing programs. The function enhancing mechanism adds a new individual image processing program and/or upgrade of an existing individual image processing program. The enhancement control mechanism determines whether the image processing mechanism includes a hardware resource corresponding to the new individual image processing program or the existing individual image processing program when the function enhancing mechanism performs such addition and/or upgrade.

### CROSS REFERENCE TO RELATED APPLICATIONS

This patent specification is based on Japanese patent application, No. 2001-290016 filed on Sep. 21, 2001, in the Japanese Patent Office, the entire contents of which are incorporated by reference herein.

### BACKGROUND OF THE INVENTION

The present invention relates to a method and apparatus for image processing, and more particularly to a method and apparatus for image processing capable of automatically adding or upgrading image processing functions without conducting a test installation of such programs. The present invention also relates to a computer readable data medium that contains computer instructions for performing the above-mentioned method of image processing.

As semiconductor and information processing technologies evolve, an image forming apparatus such as a copying machine are increasingly employing digitalized and sophisticated multifunction capability. A typical example is described in Japanese Laid-Open Patent Publication, No. 10-074163 (1998). A background digital copier described in this document performs printing, copying, and facsimile functions. These functions share an operator console, an image forming mechanism, an image reading mechanism, and a facsimile mechanism included in the digital copier. The background digital copier is provided with individual application programs such as a copier application program, a printer application program, and a facsimile application program.

In image processing in a color mode, for example, the background digital copier conducts the printer function and the copier function by commonly using various operations including a color conversion from a display color system (i.e., an RGB (red, green, and blue) color system) into a print color system (i.e., a CMYK (cyan, magenta, yellow and black) color system), a gamma conversion according to inherent printing characteristics, and a halftone control such as a dither or error diffusion control. The background digital copier also conducts the copier function and the facsimile function by commonly using a filtering operation for correcting an inherent frequency characteristics of scanned data as well as the above-mentioned color conversion, the gamma conversion and the halftone control.

Generally, image forming apparatuses including the above-described background digital copier and a general digital multifunction apparatus allow an addition of new image processing programs or an upgrade of existing image processing programs by a technician from the manufacture of the apparatus.

Japanese Laid-Open Patent Publication, No. 10-091453 describes a method for automatically upgrading image processing programs provided to a digital copier, a printer, a facsimile machine, and so on by conducting a direct communication between a machine requiring the program upgrade and a manufacture's repair server through a communications network.

However, neither Japanese Laid-Open Patent Publication No. 10-074163 or No. 10-091453 provide the capability for a user to easily install new image processing programs and upgrade existing image processing programs in an image processing apparatus without conducting a test installation.

### SUMMARY OF THE INVENTION

Accordingly, it is an object of the present invention to provide an image processing apparatus which automatically installs new image processing programs and upgrades existing image processing programs in the image processing apparatus without conducting a test installation.

Another object of the present invention is to provide a method of image processing which automatically installs new image processing programs and upgrades existing image processing programs in an image processing apparatus without conducting a test installation.

Another object of the present invention is to provide a computer readable data storing medium containing computer instructions for performing the steps of the above-mentioned method of image processing which automatically installs new image processing programs and upgrades existing image processing programs in the image processing apparatus without conducting a test installation.

To achieve the above-mentioned objects, in one example, a novel image processing apparatus includes a memory, an image processing mechanism, a function enhancing mechanism, and an enhancement control mechanism. The memory stores a plurality of individual image processing programs. The image processing mechanism includes a plurality of hardware resources performing individual image processing operations in collaboration with the plurality of individual image processing programs. The function enhancing mechanism is configured to perform an addition of a new individual image processing program to the memory and an upgrade of an existing individual image processing program in the memory. The enhancement control mechanism is configured to determine whether the image processing mechanism includes a hardware resource corresponding to the new individual image processing program or the existing individual image processing program when the function enhancing mechanism performs such addition or upgrade.

The above-mentioned novel image processing apparatus may further include a data reading mechanism configured to read an individual image processing program from a data storing medium and associated property information. With this structure, the data reading mechanism first reads associated property information, the enhancement control mechanism performs the determination based on the property information, and the data reading mechanism reads a corresponding individual image processing program when the enhancement control mechanism determines that the image processing mechanism includes a hardware resource corresponding to the read individual image processing program.

The image processing mechanism may form a plurality of function mechanisms in collaboration with the plurality of individual image processing programs stored in the memory. With this structure, the plurality of function mechanisms includes at least one of a data compressor compressing image data, a decompressor decompressing compressed image data, a filtering mechanism configured to correct a frequency transfer characteristics of the image data, an image area separation control mechanism configured to determine an image property of image data, a scaling mechanism configured to change at least one of a scale and a density of an image, a gamma converting mechanism configured to convert a gray-scale, a color converting mechanism configured to convert a display color system into a print color system, and a halftone control mechanism configured to convert the image data to reproducible halftone image data.

The image processing mechanism may include a digital signal processor.

The above-mentioned novel image processing apparatus may further include a function selecting mechanism configured to select a group of individual image processing programs corresponding to an image processing application from among the plurality of individual image processing programs stored in the memory when the image processing application is activated.

Further, to achieve the above-mentioned objects, in one example, a novel method of downloading an individual image processing program from a server through a communications network to an image processing apparatus having a plurality of individual image processing programs to perform an image processing application, includes the steps of obtaining, determining, and downloading. The obtaining step obtains property information associated with an individual image processing program to be downloaded from the server through the communications network. The determining step determines whether the individual image processing program to be downloaded to the image processing apparatus is operable in collaboration with image processing mechanisms provided to the image processing apparatus, based on the property information obtained by the obtaining step. The downloading step downloads the individual image processing program from the server into a memory of the image processing apparatus when the individual image processing program to be downloaded is determined as operable by the determining step.

The property information may include information indicative of a hardware resource to be required in the image processing apparatus to collaborate with the individual image processing program to be downloaded from the server.

The above-mentioned method may further include the step of sending a notification notifying that the individual image processing program to be downloaded is not operable when the determining step so determines.

The plurality of individual image processing programs may include at least two of a data compressing program compressing image data, a decompressing program decompressing compressed image data, a filtering program correcting a frequency transfer characteristics of the image data, an image area separation control program determining an image property of image data, a scaling program changing at least one of a scale and a density of an image, a gamma converting program converting a grayscale, a color converting program converting a display color system into a print color system, and a halftone control program converting the image data to reproducible halftone image data.

The image processing application may be one of a printing application, a copying application, a facsimile application, and a filing application.

In one example, another novel method of transferring an individual image processing program from a data storing medium to an image processing apparatus, includes the steps of obtaining, determining, and transferring. The obtaining step obtains property information associated with an individual image processing program to be transferred from the data storing medium. The determining step determines whether the individual image processing program to be transferred to the image processing apparatus is operable in collaboration with image processing mechanisms provided to the image processing apparatus, based on the property information obtained by the obtaining step. The transferring step transfers the individual image processing program from the data storing medium into a memory of the image processing apparatus when the individual image processing program to be transferred is determined as operable by the determining step.

The property information may include information indicative of a hardware resource to be required in the image processing apparatus to collaborate with the individual image processing program to be transferred from the data storing medium.

To achieve the above-mentioned objects, in one example, a computer readable data storing medium contains computer instructions for performing the steps of the above-mentioned method of image processing.

Further, to achieve the above-mentioned objects, in one example, a novel image processing apparatus includes a memory, an image processing mechanism, a function selecting mechanism, a function enhancing mechanism, and an enhancement control mechanism. The memory stores a plurality of individual image processing software sets. The image processing mechanism includes a plurality of hardware resources performing individual image processing operations in collaboration with the plurality of individual image processing software sets stored in the memory. The function selecting mechanism is configured to select a group of individual image processing software sets according to an image processing application being activated from among the plurality of individual image processing software sets stored in the memory. The function enhancing mechanism is configured to perform a function enhancing operation to add a new individual image processing software sets to the memory and to upgrade an existing individual image processing software sets in the memory. The enhancement control mechanism is configured to determine whether the image processing mechanism includes a hardware resource corresponding to the new individual image processing software sets or the existing individual image processing software sets when the function enhancing mechanism performs the function enhancing operation.

Each of the plurality of the individual image processing software sets may include an individual image processing program and associated image processing parameters.

The function enhancing mechanism may upgrade the image processing parameters when upgrading the corresponding image processing program.

The above-mentioned novel image processing apparatus may further include a parameter upgrade control mechanism configured to determine whether the function enhancing mechanism upgrades the image processing parameters when upgrading the corresponding image processing program.

The parameter upgrade control mechanism may determine whether the function enhancing mechanism upgrades the image processing parameters when upgrading the corresponding image processing program based on property information of the apparatus.

The image processing parameters to be upgraded by the function enhancing mechanism may be image processing parameters inherent to the apparatus.

The above-mentioned novel image processing apparatus may further include a communications mechanism configured to communicate with a remote terminal apparatus through a communications network. With this structure, the function enhancing mechanism performs the function enhancing operation in response to a request sent from the remote terminal apparatus via the communications mechanism.

The above-mentioned novel image processing apparatus may further include a communications mechanism configured to communicate with a server storing a plurality of individual image processing software sets, through a communications network. With this structure, the function enhancing mechanism performs the function enhancing operation by downloading a desired individual image processing software set from the server via the communications mechanism.

The communications network may be the Internet.

The above-mentioned novel image processing apparatus may further include a communications mechanism configured to communicate with a server storing a plurality of individual image processing software sets, through an Internet. With this structure, the function enhancing mechanism performs the function enhancing operation by downloading a desired individual image processing software set from the server via the communications mechanism in response to a request sent from a mobile terminal apparatus through the Internet.

Further, to achieve the above-mentioned objects, in one example, a novel method of image processing, comprising the steps of storing, providing, performing, and determining. The storing step stores a plurality of individual image processing software sets, from which a group of individual image processing software sets is selectable according to an image processing application being activated on an image processing apparatus. The providing step provides a plurality of hardware resources performing individual image processing operations in collaboration with the plurality of individual image processing software sets stored in the storing step. The performing step performs a function enhancing operation to add a new individual image processing software sets and to upgrade an existing individual image processing software sets. The determining step determines whether the hardware resources provided in the providing step includes a hardware resource corresponding to the new individual image processing software sets or the existing individual image processing software sets when the performing step performs the function enhancing operation.

Each of the plurality of the individual image processing software may set includes an individual image processing program and associated image processing parameters.

The function enhancing operation performed by the performing step may upgrade the image processing parameters when upgrading the corresponding image processing program.

The above-mentioned method may further include the step of determining whether the function enhancing operation upgrades the image processing parameters when upgrading the corresponding image processing program.

The determining step may determine whether the function enhancing operation upgrades the image processing parameters when upgrading the corresponding image processing program based on property information of the apparatus.

The image processing parameters to be upgraded by the function enhancing operation performed by the performing step may be image processing parameters inherent to the apparatus.

The above-mentioned method may further include the step of communicating with a remote terminal apparatus through a communications network. With this structure, the performing step performs the function enhancing operation in response to a request sent from the remote terminal apparatus through the communicating step.

The above-mentioned method may further include the step of communicating with a server storing a plurality of individual image processing software sets, through a communications network. With this structure, the performing step performs the function enhancing operation by downloading a desired individual image processing software set from the server through the communicating step.

The communications network may be the Internet.

The above-mentioned method may further include the step of communicating with a server storing a plurality of individual image processing software sets, through the Internet. With this structure, the performing step performs the function enhancing operation by downloading a desired individual image processing software set from the server through the communicating step in response to a request sent from a mobile terminal apparatus through the Internet.

Further, to achieve the above-mentioned objects, in one example, a novel computer readable medium storing computer instructions performs the steps of the above-mentioned method of image processing.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram of a communications system including a multifunction peripheral apparatus according to an exemplary embodiment of the present invention;

FIG. 2 is a block diagram of the multifunction peripheral apparatus of FIG. 1;

FIG. 3 is a block diagram in part of a printer controller included in the multifunction peripheral apparatus of FIG. 2;

FIG. 4 is a flowchart for explaining a program download operation performed by the printer controller of FIG. 3;

FIG. 5 is a flowchart for explaining a program installation and enhancement execution operation performed by the printer controller of FIG. 3;

FIGS. 6A and 6B are block diagrams of a printer data processor formed in the printer controller of FIG. 3;

FIGS. 7A and 7B are block diagram of a copier data processor formed in the printer controller of FIG. 3;

FIG. 8 is a flowchart for explaining a function selection operation performed by the printer controller of FIG. 3;

FIGS. 9 and 10 are block diagrams each for explaining a different image processing unit of the printer controller using a different general processor such as a central processing unit or a digital signal processor;

FIG. 11 is a block diagram of a multifunction peripheral apparatus according to another exemplary embodiment of the present invention;

FIG. 12 is a flowchart for explaining a program download operation performed by the multifunction peripheral apparatus of FIG. 11;

FIG. 13 is a block diagram of a multifunction peripheral apparatus according to another exemplary embodiment of the present invention;

FIG. 14 is a block diagram in part of a printer controller included in the multifunction peripheral apparatus of FIG. 13;

FIG. 15 is a flowchart for explaining a program download operation performed by the printer controller of FIG. 14;

FIG. 16 is a block diagram of a multifunction peripheral apparatus according to another exemplary embodiment of the present invention;

FIG. 17 is a flowchart for explaining a program download operation performed by the multifunction peripheral apparatus of FIG. 16;

FIG. 18 is a block diagram in part of a modified printer controller based on the printer controller of FIG. 3;

FIG. 19 is a flowchart for explaining a program download operation performed by the printer controller of FIG. 18;

FIG. 20 is a flowchart for explaining a program installation and enhancement execution operation performed by the printer controller of FIG. 18;

FIG. 21 is an alternative network system according to another exemplary embodiment of the present invention; and

FIG. 22 is a block diagram in part of another modified printer controller based on the printer controller of FIG. 18.

### DETAILED DESCRIPTION OF THE INVENTION

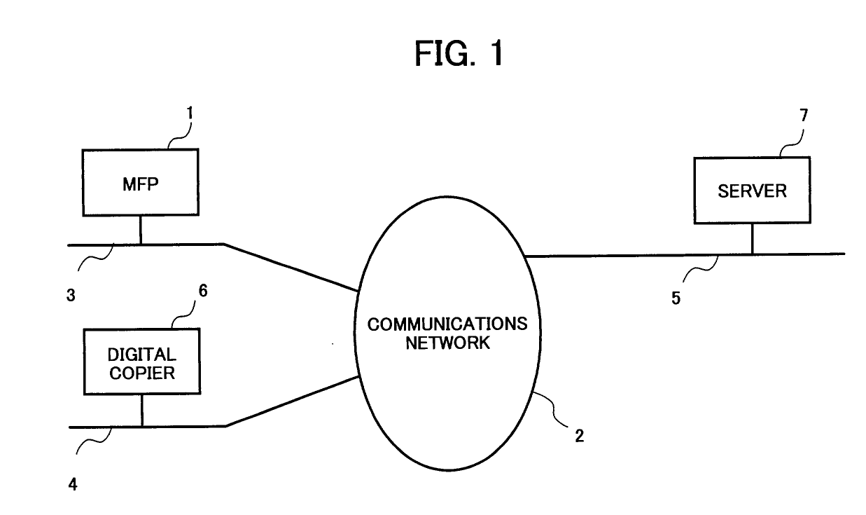

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, an MFP (multifunction-peripheral) apparatus 1 according to a preferred embodiment of the present invention is explained. The MFP apparatus 1 performs multiple functions including printing, copying, scanning, and facsimile, for example. FIG. 1 shows an exemplary network system which includes a communications network 2, and LANs (local area networks) 3-5, for example. Various kinds of equipment are operably linked to each of the LAN 3-5. For example, the MFP apparatus 1 is connected to the LAN 3, a digital copier 6 is connected to the LAN 4, and a server 7 is connected to the LAN 5. Each of the MFP 1 and the digital copier 6 exchanges data with the server 7 via the communications network 2, which may be the Internet, and the corresponding local area networks including the LANs 3-5.

In this structure, the MFP 1 can upgrade or add programs stored therein by using programs stored in the server 7 on the LAN 5. The programs stored in the server 7 includes a plurality of image processing programs, for example.

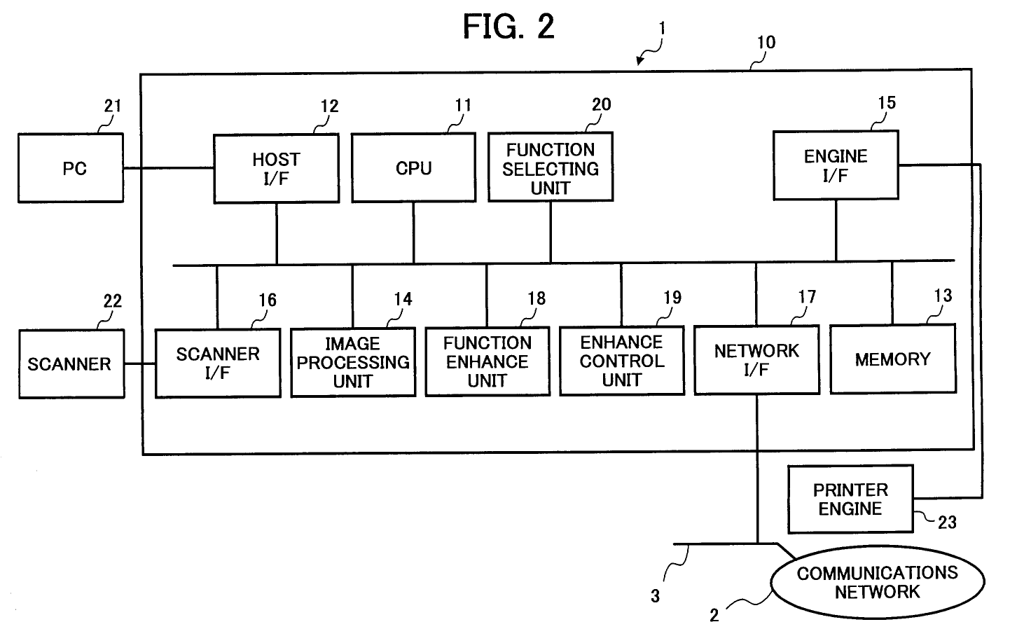

As shown in FIG. 2, the MFP 1 includes a printer controller 10, a personal computer (PC) 21, a scanner 22, and a printer engine 23. The printer controller 10 controls operations related to printing operations for printing text, graphics, and images on a recording sheet in cooperation with the printer engine 23. The PC 21 generates and sends print instructions and associated image information to the printer controller 10. The scanner 22 reads image information of document. The printer engine 23 performs the printing operations under the control by the printer controller 10.

As shown in FIG. 2, the printer controller 10 includes a CPU (central processing unit) 11, a host interface (I/F) 12, a memory 13, an image processing unit 14, an engine interface (I/F) 15, a scanner interface (I/F) 16, a network interface (I/F) 17, a function enhance unit 18, an enhance control unit 19, and a function selecting unit 20.

The CPU 11 performs the printing operation in the following manner. When the PC 21 communicates a set of image rendering commands for rendering a page of image to the host I/F 12 of the printer controller 10, the CPU 11 stores the set of image rendering commands into a predetermined memory region in the memory 13. The CPU 11 and the image processing unit 14 share the image rendering operation, that is, the CPU 11 performs an image rendering operation for text and graphics and the image processing unit 14 performs it for images. Accordingly, the CPU 11 interprets each of the set of image rendering commands stored in the memory 13 and determines whether each of the set of the image rending commands is for text, graphics, or images. When the image rendering command is determined as text or graphics, the CPU 11 performs an image rendering operation in accordance with the image rendering command for text or graphics. When the image rendering command is determined as images, the CPU 11 instructs the image processing unit 14 to perform the image rendering operation in accordance with the image rendering command for images.

When the image rendering command is for text and graphics, the CPU 11 performs the image rendering command and restores the resultant print image data of text or graphics into the memory 13.

When the image rendering command is for images, the image processing unit 14 reads an image object from the memory 13 in accordance with the instruction for the image rendering command from the CPU 11 and performs the image rendering. After rendering the image object into a print image, the image processing unit 14 restores the resultant print image data into the memory 13.

The CPU 11 completes the image rendering operation according to the set of image rendering commands upon a completion of restoring a page of the print image data including text, graphics, and images, for example, into the memory 13. After that, the CPU 11 transfers the print image data from the memory 13 to the printer engine 23 via the engine I/F 15 and instructs the printer engine 23 to print the print image data on a recording sheet. Thus, the CPU 11 controls the image printing operation.

The CPU 11 also performs a copying operation by using the above-described image printing operation. In the copying operation, the scanner 22 reads an image from a document and sends the image data to the printer controller 10 via the scanner I/F 16. Upon receiving the scanned image data, the CPU 11 stored the scanned image data into a predetermined memory region in the memory 13. After that, the CPU 11 instructs the image processing unit 14 to perform the image processing operation. Then, the image processing unit 14 reads the scanned image data from the memory 13 and performs a predetermined image processing operation. Through the image processing operation, the image processing unit 14 generates a page of print image data and restores the resultant print image data into the memory 13. Then, the image processing unit 14 completes the image processing operation. After that, the CPU 11 transfers a page of the print image data to the printer engine 23 via the engine I/F 15 and instructs the printer engine 23 to print the print image data on a recording sheet.

The MFP 1 can exchange data including the above-described print image data with the server 7 on the LAN 5 via the LAN 3 and the communications network 2, as described above.

In the printer controller 10, the function enhance unit 18 enhances the functions with respect to the image processing operations performed by the image processing unit 14 by upgrading the functions of and adding new functions to the image processing unit 14. Before the function enhance unit 18 performs the enhancement, the enhance control unit 19 determines whether upgrading or adding is appropriate. According to the determination result, the function enhance unit 18 adds or upgrades programs.

The function selecting unit 20 selects functions for the printing operation and copying operation modes.

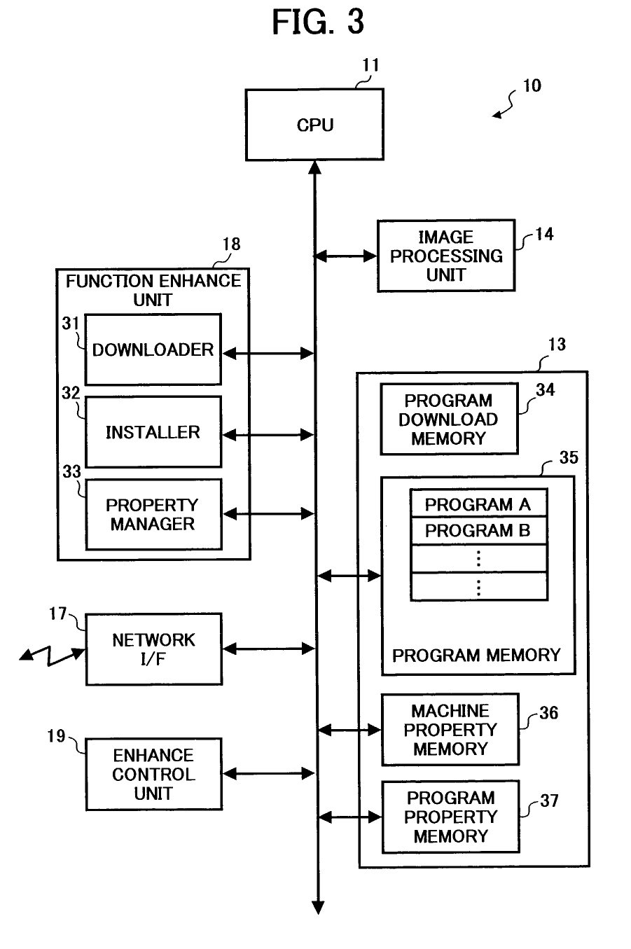

FIG. 3 shows components of the printer controller 10 providing the above-described function enhance operation. As shown in FIG. 3, these components are the CPU 11, the memory 13, the image processing unit 14, the network I/F 17, the function enhance unit 18, and the enhance control unit 19. As also shown in FIG. 3, the memory 13 includes a program download memory 34, a program memory 35, a machine property memory 36, and a program property memory 37. The function enhance unit 18 includes a downloader 31, an installer 32, and a property manager 33.

To perform the function enhancement operation, the enhance control unit 19 establishes the communications connection with the server 7 on the LAN 5 with the network I/F 17 in accordance with a function enhancement program stored in a ROM (read only memory), not shown, of the CPU 11. Then, the enhance control unit 19 searches in the server 7 one or more individual image processing programs desired to be newly added or to upgrade. When the enhance control unit 19 finds one or more desired individual image processing programs in the server 7, it determines whether each of the desired individual image processing programs found is performable by the MFP 1. When the individual image processing program found in the server 7 is determined as performable, the downloader 31 downloads the individual image processing program to the program download memory 34. After that, the installer 32 adds or upgrades the downloaded individual image processing program into the program memory 35 in collaboration with the property manager 33. Thus, one or more individual image processing programs can be newly added or replace the existing programs in the program memory 35.

The machine property memory 36 stores property data representing properties of the MFP 1, including a machine type, an identification, a serial number, etc., and the program property memory 37 stores property data representing properties of individual programs installed in the MFP 1, including program names, program versions, etc.

The function enhancement of addition or upgrades may be performed per unit of an image processing application program such as a printer application program or a copier application program. In each performance, one or more individual image processing programs associated with the printer application program or the copier application program are added or upgraded. In this case, the property data stored in the program property memory 37 stores the names of the image processing application programs, their versions, etc.

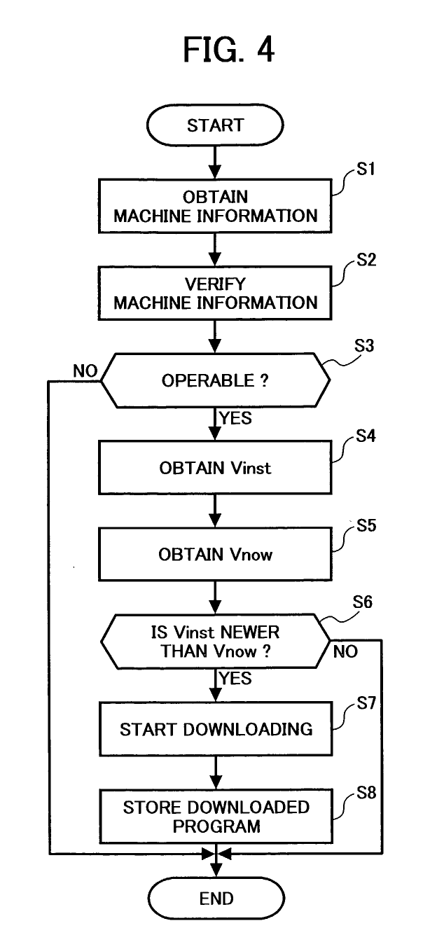

Referring to FIG. 4, an exemplary procedure of a program download operation performed by the downloader 31 in the function enhancement operation of the function enhancement unit 18 is explained. The function enhance operation is initiated, for example, when the PC 21 communicates an instruction of the function enhancement operation to the CPU 11 with designation of an image processing application program such as the printer application or copier application program, for example. Upon a receipt of such an instruction, the enhancement control unit 19 establishes a communications connection with the server 7 on the LAN 5 and sends to the server 7 a request for information associated with one or more individual image processing programs for the desired image processing application program. At this time, the CPU 11 temporarily holds the name of the desired image processing application program instructed by the PC 21 in a specific area of the program property memory 37. The program download operation of FIG. 4 starts after this point of time.

In Step S1, the enhance control unit 19 receives from the server 7 machine property information associated with machines compatible with individual image processing program candidates corresponding to the desired programs requested. Then, the enhance control unit 19 verifies in Step S2 the received machine property information with the property data of the MFP 1 stored in the machine property memory 36 and determines in Step S3 whether the individual image processing program candidates are operable in the MFP 1. When the individual image processing program candidates are determined as not operable, the procedure ends without performing the download of the individual image processing program candidates.

In the MFP 1, the program memory 35 stores a plurality of individual image processing programs, which may be grouped into the image processing application programs installed in the MFP 1, such as the printer application and the copier application. Accordingly, such group names are preferably stored in the program property memory 37 in association with the names and versions of these individual image processing programs. These individual image processing programs enable the MFP 1 to perform various image processing operations in collaboration with hardware resources (i.e., a digital signal processor (DSP)) initially provided thereto. If the MFP 1 is not provided with a hardware resource enabling an individual image processing program to operate, the MFP 1 cannot use such an individual image processing program. This is the reason why the MFP 1 needs to determine whether the individual image processing program candidates informed by the server 7 are operable with the given hardware resources by verifying the property information of machines compatible with the individual image processing program candidates with its own machine property information stored in the machine property memory 36. Accordingly, the machine property information is stored in the server 7 in association with the corresponding individual image processing programs.

When the individual image processing program candidates are determined as operable in Step S3 and the determination result of Step S3 is YES, the downloader 31 requests and obtains version information Vinst for the individual image processing program candidates from the server 7, in Step S4. The downloader 31 then reads, from the program property memory 37, program property information Vnow associated with the currently installed individual image processing programs, in Step S5. Then, in Step S6, the downloader 31 verify the version information Vinst with the program property information Vnow to determine whether the version information Vinst is newer than the program property information Vnow. When the version information Vinst is determined as newer than the program property information Vnow in Step S6 and the determination result of Step S6 is YES, the downloader 31 recognizes that the individual image processing program candidates are those to add or upgrade, and starts downloading the individual image processing programs from the server 7 corresponding to the desired programs, in Step S7. The downloaded individual processing programs are then stored in the program download memory 34. Upon a completion of the downloading, the procedure ends.

When the version information Vinst is determined as not newer than the program property information Vnow in Step S6 and the determination result of Step S6 is NO, the downloader 31 recognizes that the individual image processing program candidates are not those to add or upgrade. Then, the procedure ends.

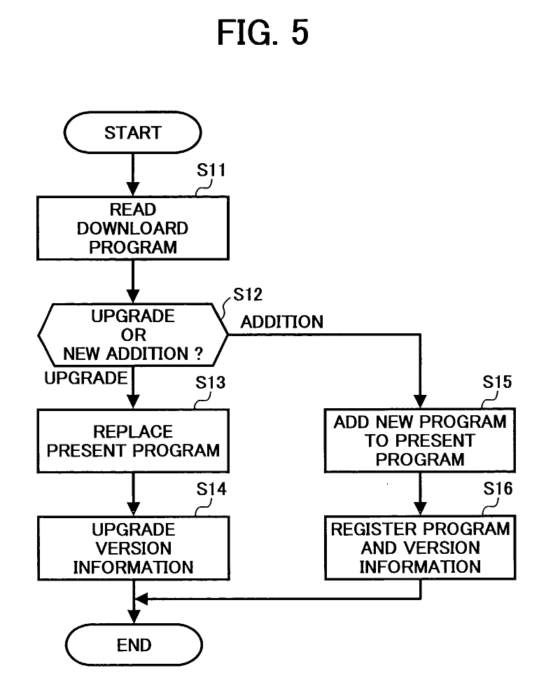

Referring to FIG. 5, an exemplary procedure of a program installation and enhancement execution operation is explained. In Step S11, the installer 32 reads the downloaded program stored in the program download memory 34 and then determines in Step S12 whether the downloaded program is for a new additional individual image processing program or an upgrade to the existing individual image processing program. For example, the determination in Step S12 is performed by comparing the name of the application program, instructed by the PC 21 and which is temporarily held in the specific area of the program property memory 37, with the program group name stored in the program property memory 37. When the determination result in Step S12 is the program upgrade, indicated as UPGRADE in FIG. 5, the installer 32 replaces in Step S13 the existing individual image processing program stored in the program memory 35 with the newly-downloaded individual image processing program. After that, in Step S14, the property manager 33 upgrades the version information in the program property memory 37 in association with the name of the program.

When the determination result in Step S12 is the program addition, indicated as ADDITION in FIG. 5, the installer 32 installs the newly-downloaded individual image processing program into the program memory 35, in Step S15. After that, in Step S16, the property manager 33 registers the program information, including the program name, and the version information associated with the added individual image processing programs, into the program property memory 37.

When more than one individual image processing programs are downloaded into the program download memory 34 in the procedure of FIG. 4, the above procedure of FIG. 5 is repeated until all the downloaded programs are processed.

The above-described operations performed by the downloader 31, the installer 32, and the property manager 33 may alternatively be performed by the CPU 11 in accordance with a pre-installed program.

To execute the image processing application, the image processing unit 14 may use each associated individual image processing program as is stored in the program memory 35 or after transferring each associated individual image processing program from the program memory 35 to the image processing unit 14.

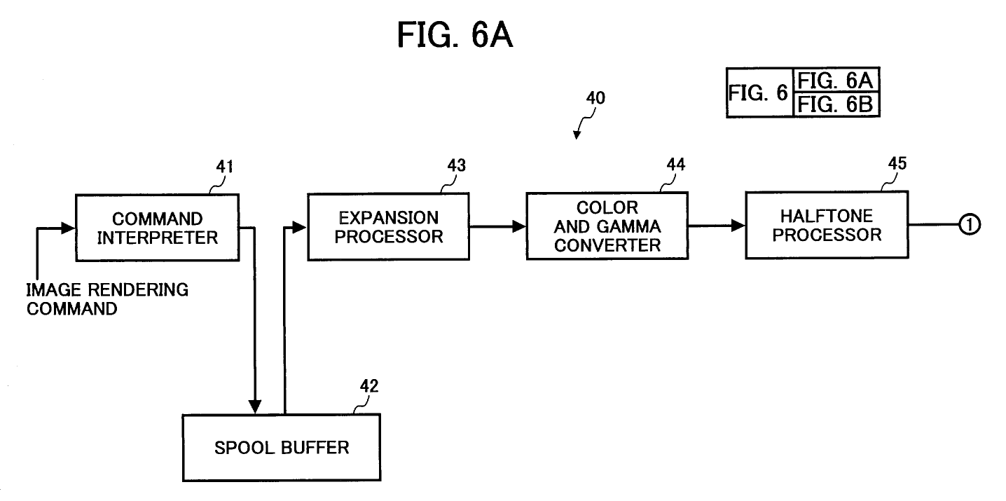

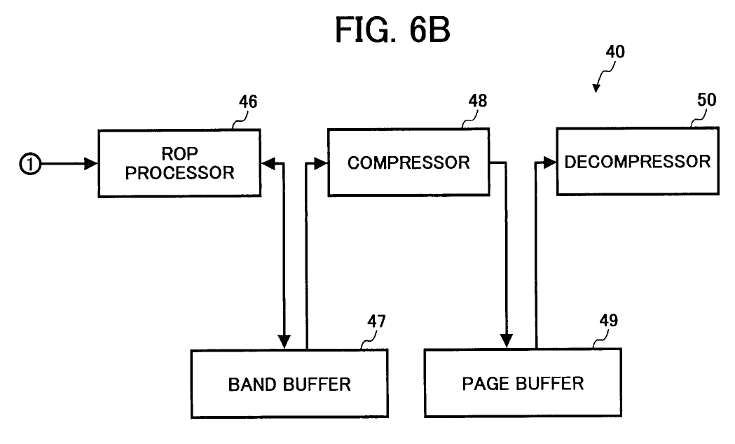

FIGS. 6A and 6B show an exemplary structure of a printer data processor 40 for handling individual image processing tasks in the printer mode, that is, in response to the image rendering command sent from the PC 21 via the CPU 11. The structure shown in FIGS. 6A and 6B is realized in the image processing unit 14 based on the hardware resources of the image processing unit 14 in collaboration with the corresponding individual image processing programs transferred from the program memory 35 or as are stored in the program memory 35.

As shown in FIGS. 6A and 6B, the printer data processor 40 of the image processing unit 14 includes various individual image processing function mechanisms such as a command interpreter 41, a spool buffer 42, an expansion processor 43, a color and gamma converter 44, a halftone processor 45. An ROP (raster operation) processor 46, a band buffer 47, a compressor 48, a page buffer 49, and a decompressor 50 are shown in FIG. 6B. The printer data processor 40 uses these individual image processing function mechanisms to handle image data in the following manner.

Upon a receipt of the image rendering command for image from the PC 21 via the CPU 11, the command interpreter 41 interprets and executes the command, and outputs compressed image object data to the spool buffer 42. Then, the expansion processor 43 reads the compressed image object data from the spool buffer 42 and decompresses the data. Next, the color and gamma converter 44 converts the color data from the video color data (i.e., RGB data) into the printer color data (i.e., YMCK data). In addition, the color and gamma converter 44 performs a gamma conversion in accordance with a gray-scale characteristic inherent to the printer engine 23 of the MFP 1.

Subsequently, the halftone processor 45 performs an area gray-scale conversion or a density modulation operation in accordance with a printing capability of the printer engine 23. Upon receiving the halftone image rendering data from the halftone processor 45, the ROP processor 46 executes a raster operation (ROP) command for rendering the image with overlaying the rendered image data with background image data and places the rendered image the band buffer 47.

Upon a completion of the image rendering, the compressor 48 compresses the rendered image data into a region of the page buffer 49. Until all the regions of the page buffer 49 are covered, the above-described sequential operations are repeated. Next, the decompressor 50 reads the page data from the page buffer 49 and decompresses the page data. The decompressed data is then transmitted to the printer engine 23 via the engine I/F 15.

In this way, the printer data processor 40 of the image processing unit 14 handles the image data.

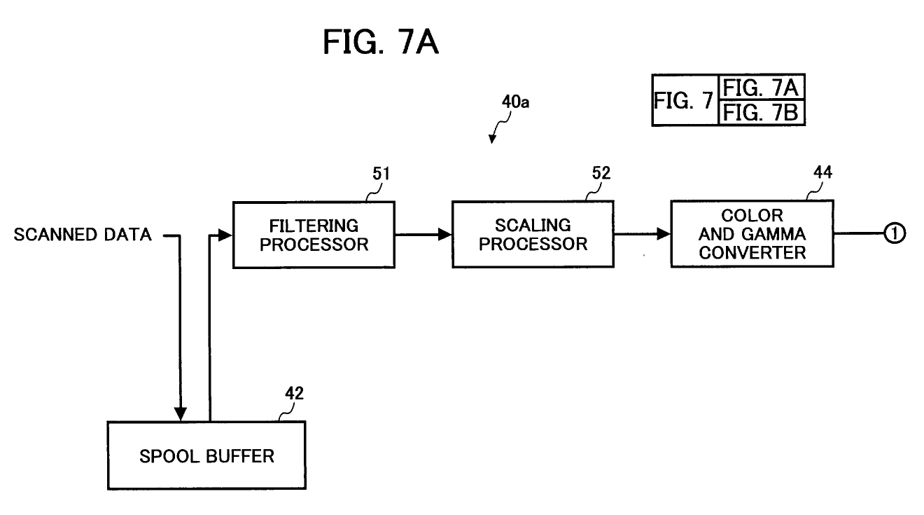

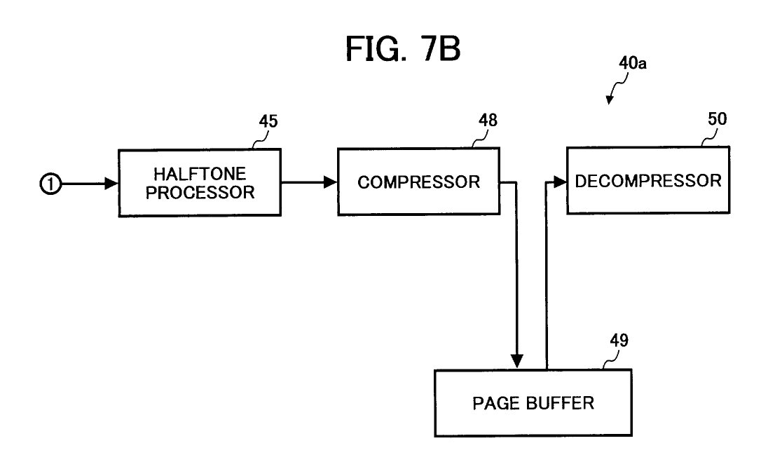

FIGS. 7A and 7B show a copier data processor 40a for handling image processing tasks according to the copying instruction of the copying mode. This copier data processor 40a shown in FIGS. 7A and 7B is realized in the image processing unit 14 based on the hardware resources included in the image processing unit 14 in collaboration with the corresponding individual image processing programs transferred from the program memory 35 or as are stored in the program memory 35.

The copier data processor 40a of the image processing unit 14 includes various individual image processing function mechanisms such as the spool buffer 42, a filtering processor 51, a scaling processor 52, the color and gamma converter 44, the halftone processor 45, the compressor 48, the page buffer 49, and the decompressor 50 are shown in FIG. 7B. The copier data processor 40a uses these individual image processing function mechanisms to handle the image data in the following manner.

The data read from a document by the scanner 22 is stored in the spool buffer 42. Then, the filtering processor 51 performs a filtering process in accordance with a predetermined frequency transfer characteristic (i.e., a space frequency characteristic) relative to the data read from the spool buffer 42. Then, the scaling processor 52 performs a scaling process in accordance with a designated scale relative to the filtered data. Then, the color and gamma converter 44 converts the color data from the video color data (i.e., RGB data) into the printer color data (i.e., YMCK data). In addition, the color and gamma converter 44 performs a gamma conversion in accordance with a gray-scale characteristic inherent to the printer engine 23 of the MFP 1. Next, the halftone processor 45 performs the area gray-scale conversion or the density modulation operation in accordance with a printing capability of the printer engine 23. Then, the compressor 48 compresses the image data into a region of the page buffer 49. Until all the regions of the page buffer 49 is covered, the above-described sequential operations are repeated. Finally, the decompressor 50 reads the page data from the page buffer 49 and decompresses the page data. The decompressed data is then transmitted to the printer engine 23 via the engine I/F 15.

In this way, the copier data processor 40a of the image processing unit 14 handles the image data.

The image processing unit 14 may further includes other individual image processing function mechanisms such as an image area separation mechanism for determining an image property of image data and separating areas of the image, for example. As another example, a scaling processor for scaling the size or the density of an image may also be realized in the image processing unit 14.

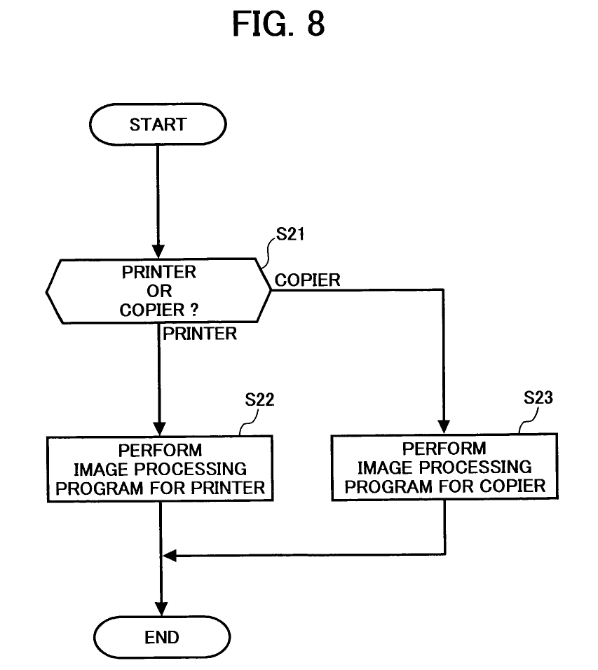

FIG. 8 shows an exemplary procedure of a function selection operation performed by the function selecting unit 20 (see FIG. 2) to select one of the printer data processor 40 and the copier data processor 40a in accordance with an image processing mode designated as the printer mode or the copier mode.

As shown in FIG. 8, the function selecting unit 20 of the printer controller 10 determines in Step S21 whether the function designated by the user is the copying mode or the printer mode. When the function designated by the user is determined as the printer mode and the determination result of Step S21 is PRINTER, the image processing unit 14 processes the image data in accordance with the printer image processing application program using the printer data processor 40 shown in FIGS. 6A and 6B, in Step S22. When the function designated by the user is determined as the copier mode and the determination result of Step S21 is COPIER, the image processing unit 14 processes the image data in accordance with the copier image processing application program using the copier data processor 40a shown in FIGS. 7A and 7B, Step S23. When either the printer image processing application program or the copier image processing application program is completed, the procedure returns to the beginning thereof.

The above function selection may alternatively be determined within the currently acting image processing application.

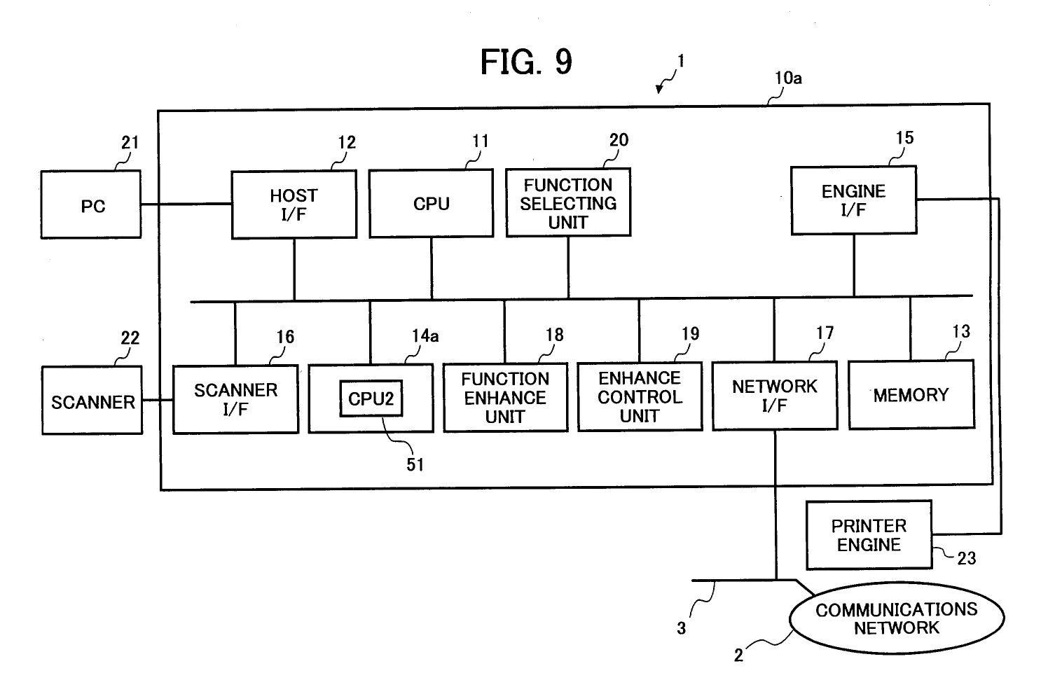

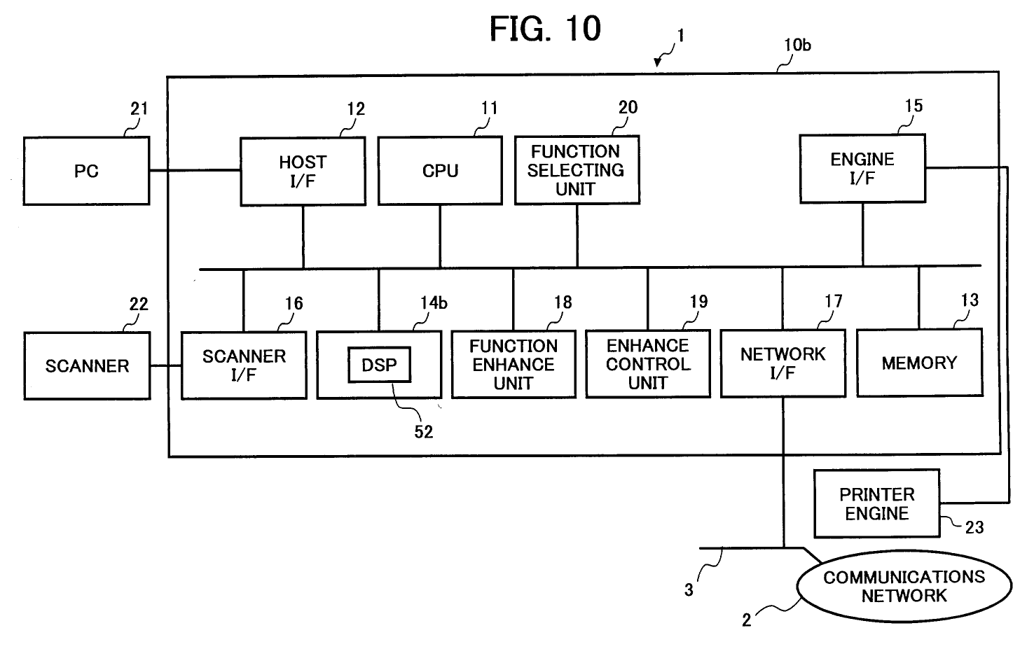

FIG. 9 shows an image processing unit 14a using a CPU2 51, a general-purposed processor, for performing the above-described various individual image processing operations. Also, FIG. 10 shows an image processing unit 14b using a digital signal processor (DSP) 52 for performing the above-described various image processing operations. The both image processing units 14a and 14b shown in FIGS. 9 and 10, respectively, operate in accordance with the procedure explained with reference to FIG. 8.

The above-mentioned DSP 52 may alternatively be a general-purposed numeric operation processor. Further, the DSP 52 may alternatively be a middle-ware (i.e., a program) optimized to implement the functions performed by the image processing unit 14b in a manner similar to a video processor using a SIMD (single-instruction multiple-data stream) calculation program.

Although the above description focuses on the sharing of the image processing hardware resources by the printer mode and the copier mode, the MFP 1 realizes other cases of sharing the image processing hardware resources. For example, the image processing hardware resources can be shared by the printer mode and the facsimile mode, the printer mode and the filing mode, the copier mode and the facsimile mode, and so on. The image processing hardware resources can also be shared by all of these modes in a similar manner.

According to the present preferred embodiment, the MFP 1 performs the function enhancement operation which includes the step to determine whether the individual image processing program candidate is performable in collaboration with the hardware resources of the MFP 1 before downloading the program itself. Therefore, the user can avoid the steps to perform a test installation to check if the program is operable on the MFP 1. Furthermore, the MFP 1 automatically downloads the program determined as performable, thereby eliminating the steps for procuring the program and the downloading of wasteful programs. In addition, the MFP 1 performs the above determination using the simple property information and the determination itself is made in a relatively simple manner.

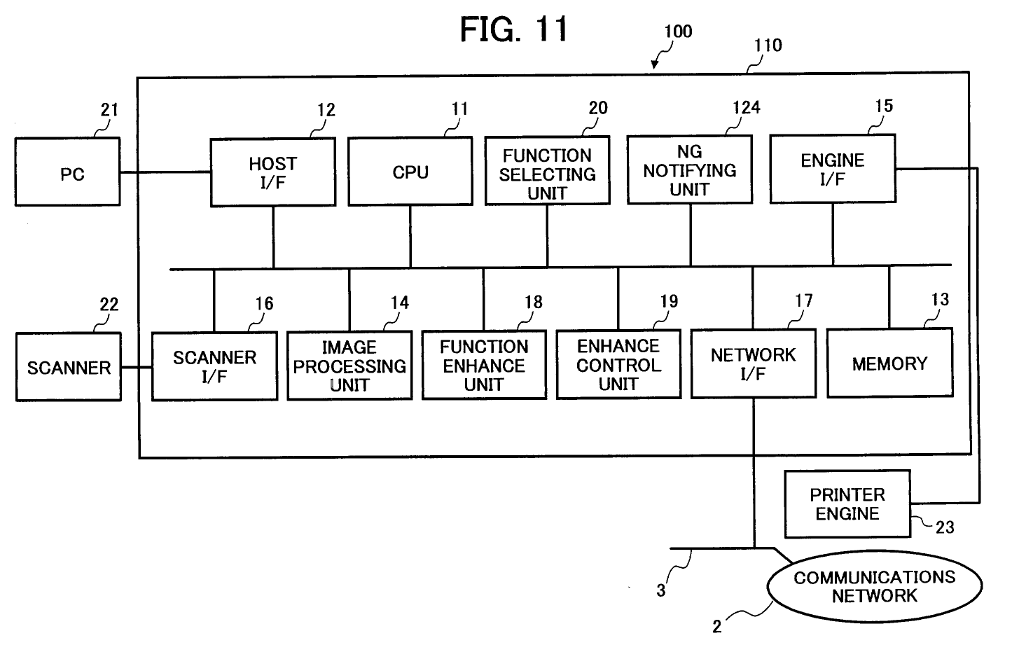

Next, an MFP (multifunction-peripheral) apparatus 100 according to another preferred embodiment of the present invention is explained with reference to FIG. 11. The MFP apparatus 100 of FIG. 11 is similar to the MFP 1 of FIG. 2, except for an NG (not good) notifying unit 124. The NG notifying unit 124 returns a notification indicating that the individual image processing program candidate is determined as not good to the PC 21. Upon receiving such notification, the PC 21 displays a message indicating to the user that the individual image processing program candidate is determined as not good. The PC 21 may output a voice message indicating the same. In the MFP 100, the printer controller 10 added with the NG notifying unit 124 is referred to as a printer controller 110, for the sake of clarity.

With the above-described structure, the MFP 100 of FIG. 11 performs the operations, including the printing operations either in the printer mode or the copier mode and the function enhancement operation as well as the communications operation with the server 7, in a manner similar to the MFP 1 of FIG. 2, except for the NG notifying operation of the NG notifying unit 124.

The function enhancement unit 18 of the printer controller 110 upgrades new functions or upgrades existing functions associated with the image processing operations performed by the image processing unit 14. The enhancement control unit 19 however determines whether the function to be added or to upgrade is appropriate before the function enhancement unit 18 performs the enhancement. When the determination result indicates that the function to be added or to upgrade is appropriate on the MFP 100, the function enhancement unit 18 performs the enhancement operations. However, when the determination result indicates that the function to be added or to upgrade is inappropriate on the MFP 100, the NG notifying unit 124 notifies the PC 21 that the function to be added or to upgrade is inappropriate on the MFP 100, through the host I/F 12.

To perform the function enhancement operation with this structure shown in FIG. 11, the enhancement control unit 19 establishes the communications connection with the server 7 on the LAN 5 with the network I/F 17 in accordance with a function enhancement program stored in a ROM (read only memory), not shown, of the CPU 11. Then, the enhancement control unit 19 searches in the server 7 one or more individual image processing programs desired to be newly added or to upgrade. When the enhancement control unit 19 finds one or more desired individual image processing programs in the server 7, it determines whether each of the desired individual image processing programs found is performable by the MFP 1. When the individual image processing program found in the server 7 is determined as performable, the downloader 31 downloads the individual image processing program to the program download memory 34. After that, the installer 32 adds or upgrades the downloaded individual image processing program into the program memory 35 in collaboration with the property manager 33. Thus, one or more individual image processing programs can be added or replace the old programs in the program memory 35.

However, when the individual image processing program found in the server 7 is determined as not performable, the downloader 31 does not perform the downloading and the NG notifying unit 124 sends to the PC 21 a notification indicating that the individual image processing program found in the server 7 is not performable on the MFP 100 so that the PC 21 indicates the same to the user. The function enhancement operation then ends.

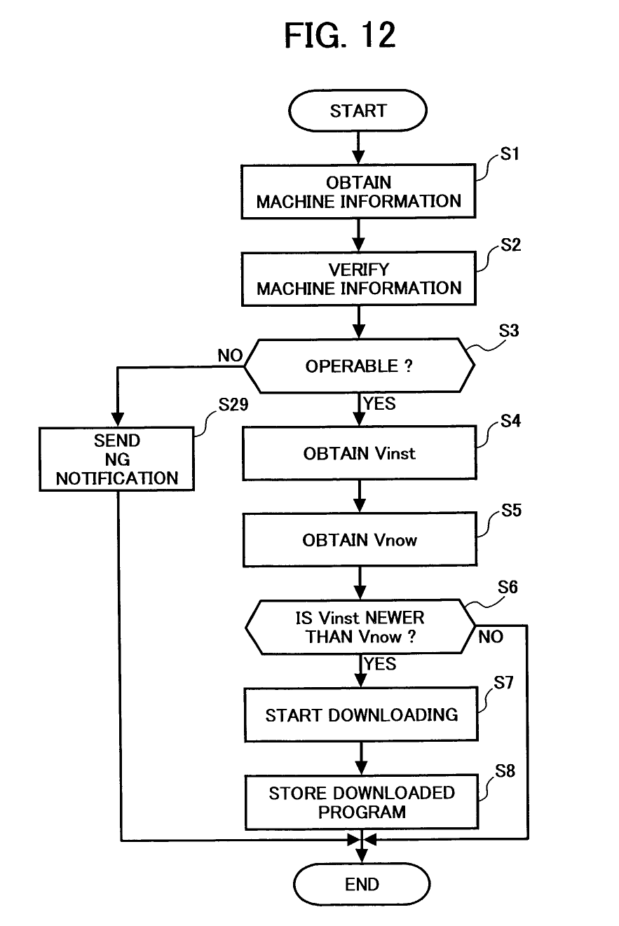

FIG. 12 shows an exemplary procedure of a program download operation performed by the downloader 31 in the MFP 100. As is the case with the MFP 1 of FIG. 2, the program download operation is performed in the course of the function enhancement operation initiated, for example, when the PC 21 sends an instruction of the function enhancement operation to the CPU 11 with designation of an image processing application program such as the printer application or copier application program, for example. The procedure of the program download operation of FIG. 12 is similar to that shown in FIG. 4 for the MFP 1 of FIG. 2, except for Step S29.

In the flowchart of FIG. 12, when the individual image processing program candidates are determined as not operable, the process proceeds to Step S29 in which the NG notifying unit 124 sends to the PC 21 a notification indicating that the individual image processing program candidates are determined as not operable. Thereby, the PC 21 subsequently indicates the same to the user. Next, the procedure ends without performing the download of the individual image processing program candidates.

Thus, the MFP 100 having the NG notifying unit 124 in the printer controller 110 can indicate to the user that the desired individual image processing program is not installable on the MFP 100 when the program candidate is so determined.

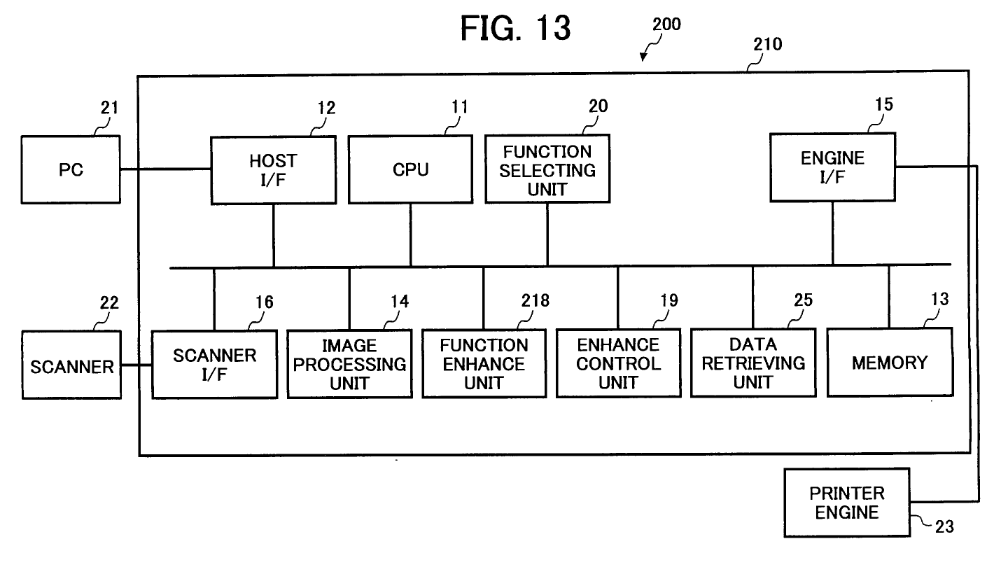

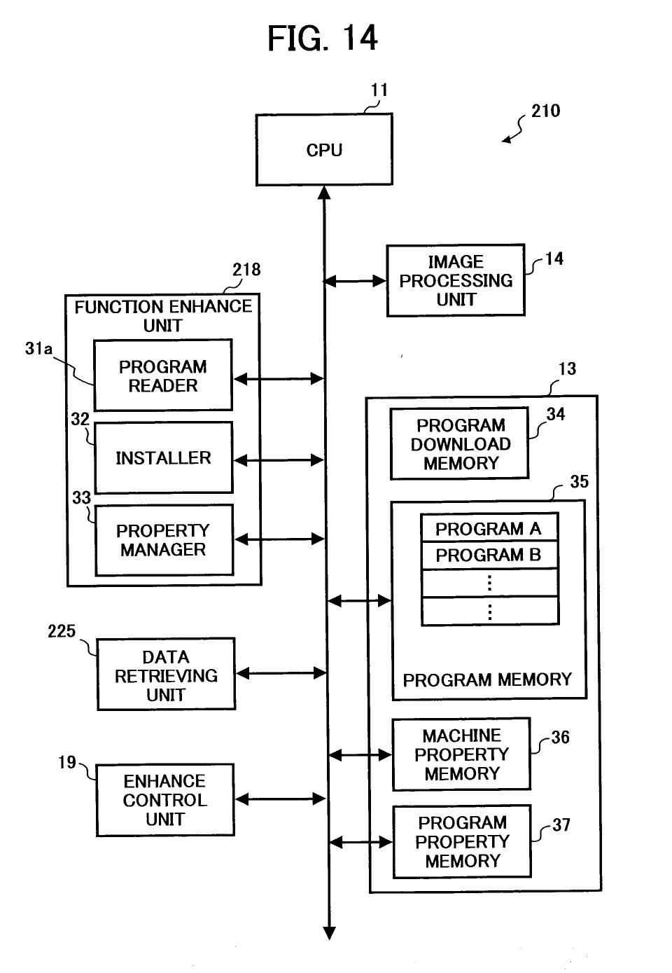

Next, an MFP (multifunction-peripheral) apparatus 200 according to another preferred embodiment of the present invention is explained with reference to FIG. 13. The MFP apparatus 200 of FIG. 13 is similar to the MFP 1 of FIG. 2, except for a printer controller 210. The printer controller 210 includes a data retrieving unit 25 in place of the network I/F 17 and a function enhance unit 218 having a program reader 31a in place of the function enhancement unit 18 having the downloader 31 (FIG. 14). The data retrieving unit 25 retrieves data from a data storing medium such as a CD-ROM, a floppy disc, a hard disc, a memory card, and the like. In this example, the data stored in the data storing medium includes various individual image processing programs and associated property information. That is, the MFP 200 performs the function enhancement operation by obtaining the desired individual image processing programs and associated property information from a data recording medium with the data retrieving unit 225 and the function enhancement unit 218, instead of conducting the network communications with the server 7.

With the above-described structure, the MFP 200 of FIG. 13 performs the operations, including the printing operations either in the printer mode or the copier mode and the function enhancement operation, in a manner similar to the MFP 1 of FIG. 2, except for the above data retrieving operation from a data storing medium.

FIG. 14 shows some components of the above printer controller 210 needed for the function enhancement operation. As shown in FIG. 14, these components are the CPU 11, the memory 13, the image processing unit 14, a function enhancement unit 218, the enhance control unit 19, and the data retrieving unit 25. The function enhance unit 218 includes the program reader 31a, the installer 32, and the property manager 33.

To perform the function enhancement operation, the enhance control unit 19 reads a data storing medium in accordance with a function enhancement program stored in a ROM (read only memory), not shown, of the CPU 11. Then, the enhance control unit 19 searches in the data storing medium one or more individual image processing programs desired to be newly added or to upgrade. When the enhance control unit 19 finds one or more desired individual image processing programs in the data storing medium, it determines whether each of the desired individual image processing programs found is performable by the MFP 200. When the individual image processing program found in the data storing medium is determined as performable, the program reader 31a retrieves and stores the individual image processing program to the program download memory 34. After that, the installer 32 adds or upgrades the downloaded individual image processing program into the program memory 35 in collaboration with the property manager 33. Thus, one or more individual image processing programs can be newly added or replace the old programs in the program memory 35.

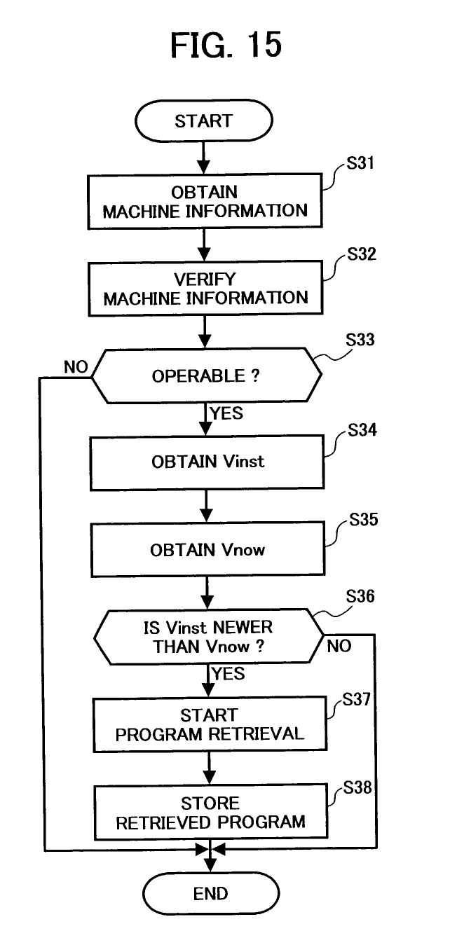

FIG. 15 shows an exemplary procedure of a program retrieving operation performed by the program reader 31a in the MFP 200. As is similar to the program download operation performed by the MFP 1 of FIG. 2, the program retrieving operation of the MFP 200 is conducted in the course of the function enhancement operation initiated when the PC 21 sends an instruction of the function enhancement operation to the CPU 11 with designation of the printer application or copier application program, for example, as the image processing application program. The procedure of the program retrieving operation of FIG. 14 is basically similar to the program download operation shown in FIG. 4 for the MFP 1 of FIG. 2, except for some minor differences described below.

As described above, the function enhancement operation is initiated, for example, when the PC 21 communicates an instruction of the function enhancement operation to the CPU 11 with designation of the printer application or copier application program, for example, as an image processing application program. The CPU 11 temporarily holds the name of the desired image processing application program instructed by the PC 21 in a specific area of the program property memory 37. The program download operation of FIG. 15 starts after this point of time.

In Step S31, the enhance control unit 19 reads a data storing medium to obtain machine property information associated with machines compatible with individual image processing program candidates corresponding to the desired programs requested. Then, the enhance control unit 19 verifies in Step S32 the received machine property information with the property data of the MFP 200 stored in the machine property memory 36 and determines in Step S33 whether the individual image processing program candidates are operable in the MFP 200. When the individual image processing program candidates are determined as not operable, the procedure ends without a retrieval of the individual image processing program candidates.

When the individual image processing program candidates are determined as operable in Step S33 and the determination result of Step S33 is YES, the program reader 31a retrieves and obtains version information Vinst for the individual image processing program candidates from the data storing medium, in Step S34. The program reader 31a then reads, from the program property memory 37, program property information Vnow associated with the currently installed individual image processing programs, in Step S35. Then, in Step S36, the program reader 31a verify the version information Vinst with the program property information Vnow to determine whether the version information Vinst is newer than the program property information Vnow. When the version information Vinst is determined as newer than the program property information Vnow in Step S36 and the determination result of Step S36 is YES, the program reader 31a recognizes that the individual image processing program candidates are those to add or upgrade, and starts downloading the individual image processing programs from the data storing medium corresponding to the desired programs, in Step S37. The retrieved individual processing programs are then stored in the program download memory 34. Upon a completion of the program retrieval, the procedure ends.

When the version information Vinst is determined as not newer than the program property information Vnow in Step S36 and the determination result of Step S36 is NO, the program reader 31a recognizes that the individual image processing program candidates are not those to add or upgrade. Then, the procedure ends.

In this way, the MFP 200 effectively adds and upgrades the desired individual image processing program from a data storing medium without conducting a test installation, by retrieving therefrom the desired individual image processing programs as well as the program property information and the required machine property information associated with the programs.

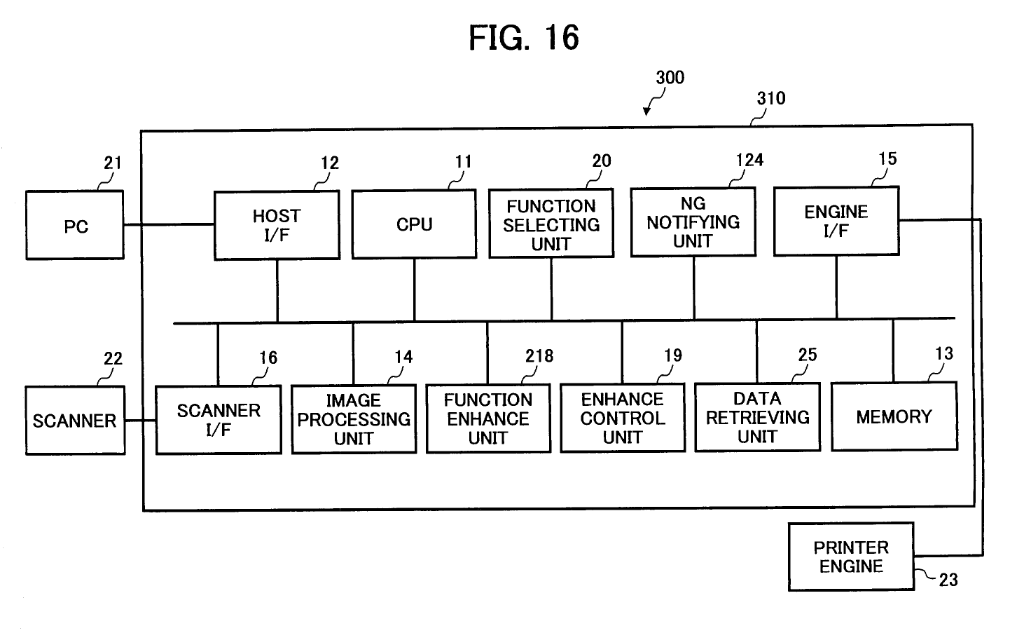

Next, an MFP (multifunction-peripheral) apparatus 300 according to another exemplary embodiment of the present invention is explained with reference to FIG. 16. The MFP apparatus 300 of FIG. 16 is similar to the MFP 200 of FIG. 13, except for the notifying unit 124 which is explained in the description of the MFP 100 of FIG. 11. As described above, the NG notifying unit 124 returns a notification indicating that the individual image processing program candidate is determined as not good to the PC 21. Upon receiving such notification, the PC 21 displays a message indicating to the user that the individual image processing program candidate to be retrieved from a data storing medium is determined as not good. The PC 21 may output a voice message indicating the same. In the MFP 300, the printer controller 200 added with the NG notifying unit 124 is referred to as a printer controller 310, for the sake of clarity.

With the above-described structure, the MFP 300 of FIG. 16 performs the operations, including the printing operations either in the printer mode or the copier mode and the function enhancement operation, in a manner similar to the MFP 200 of FIG. 13, except for the NG notifying operation of the NG notifying unit 124.

The function enhance unit 218 of the printer controller 310 upgrades new functions or upgrades existing functions associated with the image processing operations performed by the image processing unit 14. The enhance control unit 19 however determines whether the function to be added or to upgrade is appropriate before the function enhance unit 218 performs the enhancement. When the determination result indicates that the function to be added or to upgrade is appropriate on the MFP 300, the function enhance unit 218 performs the enhancement operations. However, when the determination result indicates that the function to be added or to upgrade is inappropriate on the MFP 300, the NG notifying unit 124 notifies the PC 21 that the function to be added or to upgrade is inappropriate on the MFP 300, through the host I/F 12.

To perform the function enhancement operation with this structure shown in FIG. 16, the enhance control unit 19 reads a data storing medium in accordance with a function enhancement program stored in a ROM (read only memory), not shown, of the CPU 11. Then, the enhance control unit 19 searches in the data storing medium one or more individual image processing programs desired to be newly added or to upgrade. When the enhance control unit 19 finds one or more desired individual image processing programs in the data storing medium, it determines whether each of the desired individual image processing programs found is performable by the MFP 300. When the individual image processing program found in the data storing medium is determined as performable, the program reader 31a retrieves and stored the individual image processing program to the program download memory 34. After that, the installer 32 adds or upgrades the retrieved individual image processing program into the program memory 35 in collaboration with the property manager 33. Thus, one or more individual image processing programs can be added or replace the old programs in the program memory 35.

However, when the individual image processing program found in the data storing medium is determined as not performable, the program reader 31a does not perform the program retrieval and the NG notifying unit 124 sends to the PC 21 a notification indicating that the individual image processing program found in the data storing medium is not performable on the MFP 300 so that the PC 21 indicates the same to the user. The function enhancement operation then ends.

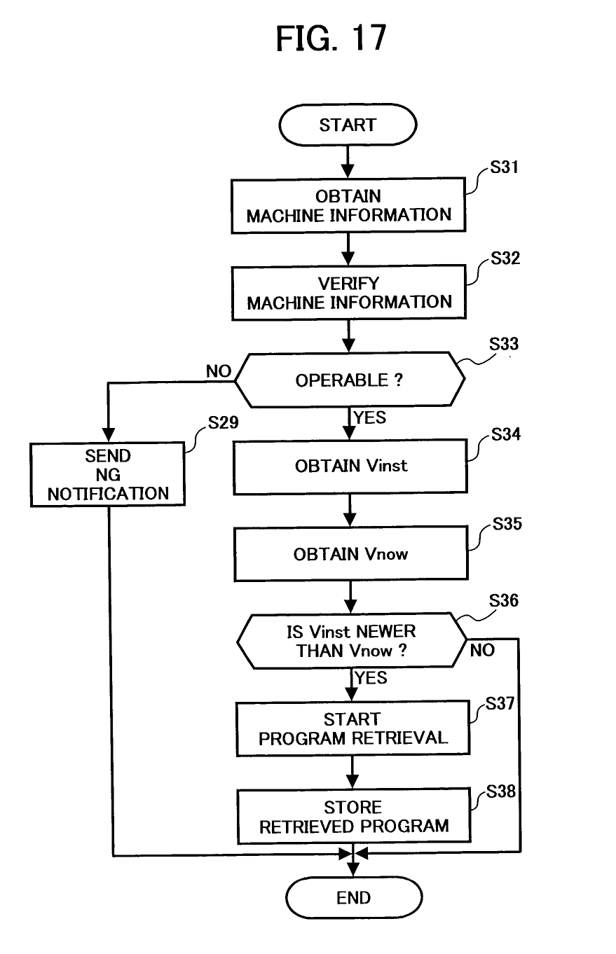

FIG. 17 shows an exemplary procedure of a program download operation performed by the program reader 31a in the MFP 300. As is the case with the MFP 200 of FIG. 13, the program retrieval operation is performed in the course of the function enhancement operation which is initiated, for example, when the PC 21 sends an instruction of the function enhancement operation to the CPU 11 with designation of the printer application or copier application program, for example, as an image processing application program. The procedure of the program retrieval operation of FIG. 17 is similar to that shown in FIG. 15 for the MFP 200 of FIG. 13, except for Step S29, the step for sending an NG notification to the PC 21. This operation in Step S29 is explained in the description for the MFP 100 of FIG. 11 with reference to the flowchart of FIG. 12.

In the flowchart of FIG. 17, when the individual image processing program candidates from a data storing medium are determined as not operable, the process proceeds to Step S29 in which the NG notifying unit 124 sends to the PC 21 a notification indicating that the individual image processing program candidates are determined as not operable. Thereby, the PC 21 subsequently indicates the same to the user. Next, the procedure ends without performing the program retrieval of the individual image processing program candidates from the data storing medium.

Thus, the MFP 300 having the NG notifying unit 124 in the printer controller 310 can indicate to the user that the desired individual image processing program stored in the data storing medium is not installable on the MFP 300 when the program candidate is so determined.

The above-described function enhancement operations performed by the MFPs 1, 100, 200, and 300 may be implemented into a computer program written in a general computer readable data medium or expressed in a carrier wave. This computer program may allow a different digital multi-function machine or a digital image forming apparatus such as the digital copier 6 to perform the function enhancement operation.

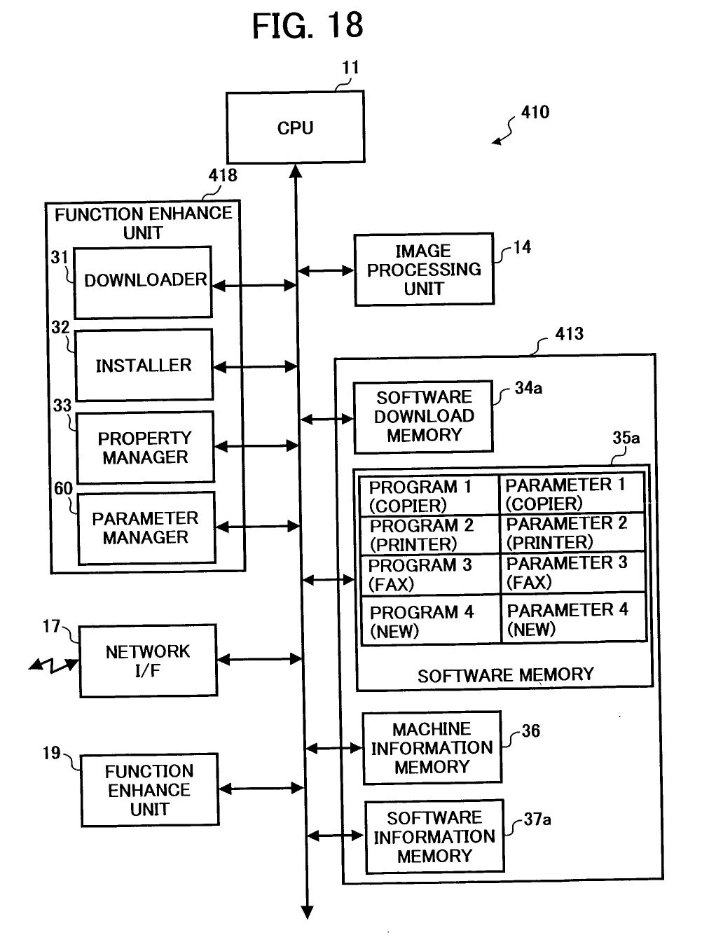

Next, a modified printer controller 410 according to another preferred embodiment is explained with reference to FIG. 18. The modified printer controller 410 of FIG. 18 is similar to the printer controller 10 of FIG. 3, except for a memory 413 and a function enhance unit 418. The memory 413 is similar to the memory 13 shown in FIG. 3, except for a software download memory 34a, a software memory 35a, and a software property memory 37a. Also, the function enhance unit 418 is similar to the function enhance unit 18 shown in FIG. 3, except for a parameter control unit 60.

With the above components, the function enhancement operation performed by the printer controller 410 includes not only individual image processing programs but also various image processing parameters associated with the programs. In this discussion a set of individual image processing program and associated image processing parameters is referred to as a set of individual image processing software. The software download memory 34a temporarily stores one or more sets of individual image processing software when they are downloaded. The software sets downloaded to the software download memory 34a are installed in the software memory 35a in a way as shown in FIG. 18. The sets of individual image processing software may be separated in the application groups such as the printer application group, the copier application group, the facsimile application group, the filing application group, a new application group, and so on, as shown in FIG. 18. The parameter control unit 60 determines whether the image processing parameters included in each set of the individual image processing software are needed to upgrade the parameters already existing in the software memory 35a in association with a corresponding set of the individual image processing software.

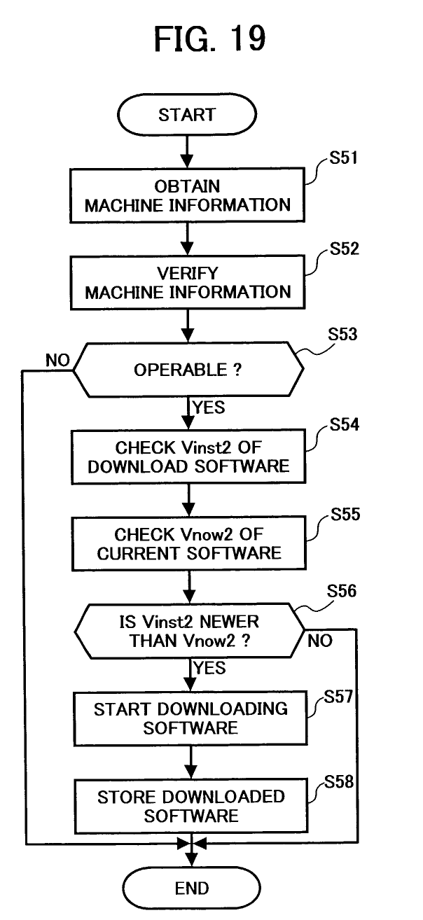

FIG. 19 shows an exemplary procedure of a software download operation performed by the downloader 31 in the function enhancement operation of the function enhance unit 418. The software download operation of FIG. 19 is basically similar to the program download operation shown in FIG. 4, except that the software download operation downloads sets of software instead of programs.

The function enhancement operation is initiated, for example, when the PC 21 sends an instruction of the function enhancement operation to the CPU 11 with designation of image processing application software such as the printer application or copier application software, for example. Upon a receipt of such an instruction, the enhance control unit 19 establishes a communications connection with the server 7 on the LAN 5 and sends to the server 7 a request for information associated with one or more sets of individual image processing software for the desired image processing application software. As described above, each set of individual image processing application software includes individual image processing program and associated image processing parameters. At this time, the CPU 11 temporarily holds the name of the desired image processing application software instructed by the PC 21 in a specific area of the software property memory 37a. The software download operation of FIG. 19 starts after this point of time.

In Step S51, the enhance control unit 19 receives from the server 7 machine property information associated with machines compatible with individual image processing software candidates corresponding to the desired software requested. Then, the enhance control unit 19 verifies in Step S52 the received machine property information with the property data of the host MFP apparatus stored in the machine property memory 36 and determines in Step S53 whether the individual image processing software candidates are operable in the host MFP apparatus. When the individual image processing software candidates are determined as not operable, the procedure ends without performing the download of the individual image processing software candidates.

When the individual image processing software candidates are determined as operable in Step S53 and the determination result of Step S53 is YES, the downloader 31 requests and obtains version information Vinst2 for the individual image processing software candidates from the server 7, in Step S54. The downloader 31 then reads, from the software property memory 37a, software property information Vnow2 associated with the currently installed individual image processing software, in Step S55. Then, in Step S56, the downloader 31 verify the version information Vinst2 with the software property information Vnow2 to determine whether the version information Vinst2 is newer than the software property information Vnow2. When the version information Vinst2 is determined as newer than the software property information Vnow2 in Step S56 and the determination result of Step S56 is YES, the downloader 31 recognizes that the individual image processing software candidates are those to add or upgrade, and starts downloading the individual image processing software from the server 7 corresponding to the desired software, in Step S57. The downloaded individual processing software are then stored in the software download memory 34a. Upon a completion of the downloading, the procedure ends.

When the version information Vinst2 is determined as not newer than the software property information Vnow2 in Step S56 and the determination result of Step S56 is NO, the downloader 31 recognizes that the individual image processing software candidates are not those to add or upgrade. Then, the procedure ends.

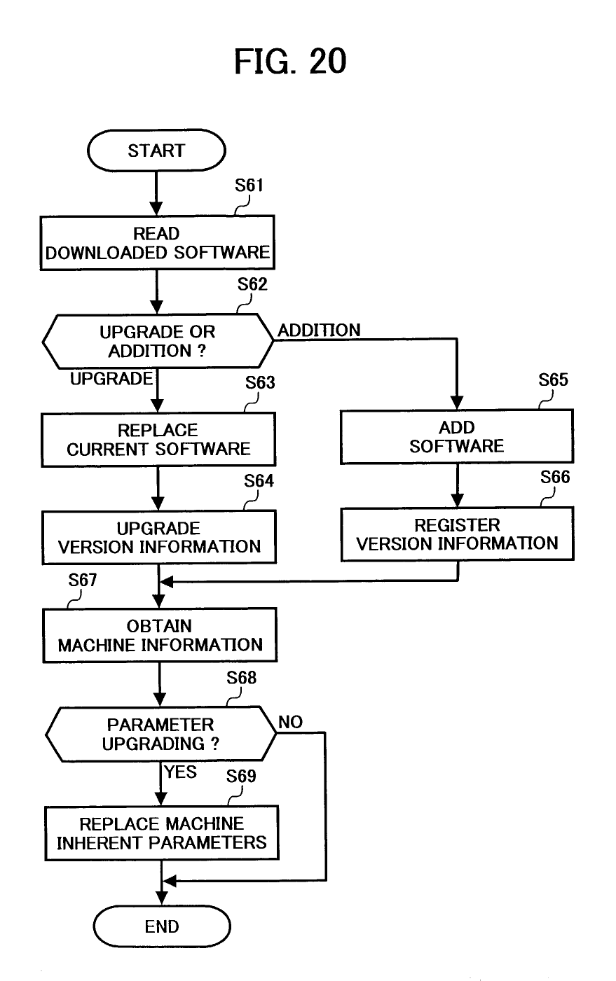

Referring to FIG. 20, an exemplary procedure of a software installation and enhancement execution operation is explained. In Step S61, the installer 32 reads the downloaded software temporarily stored in the software download memory 34a and then determines in Step S62 whether the downloaded software is for new additional individual image processing software or an upgrade to the existing individual image processing software. For example, the determination in Step S62 is performed by comparing the name of the application software, instructed by the PC 21 and which is temporarily held in the specific area of the software property memory 37a, with the software group name stored in the software property memory 37a. When the determination result in Step S62 is the software upgrade, indicated as UPGRADE in FIG. 20, the installer 32 replaces in Step S63 an individual image processing program of the existing individual image processing software stored in the software memory 35a with an individual image processing program of the newly-downloaded individual image processing software. After that, in Step S64, the property manager 33 upgrades the program version information in the software property memory 37a in association with the name of the software.

When the determination result in Step S62 is the software addition, indicated as ADDITION in FIG. 20, the installer 32 installs an individual image processing program of the newly-downloaded individual image processing software into the software memory 35a, in Step S65. After that, in Step S66, the property manager 33 registers the software information, including the software name, and the program version information associated with the added individual image processing program, into the software property memory 37a.

After the process of Step S64 or Step S66, the parameter control unit 60 reads the machine property memory 36 to obtain the machine property information inherent to the host MFP apparatus, in Step S67. Then, based on the obtained machine property information, the parameter control unit 60 determines in Step S68 whether a set of the image processing parameters included in the downloaded individual image processing software is needed to replace the existing parameters. When the determination result in Step S68 is YES, the parameter control unit 60 upgrades the parameters in Step S69. When the determination result in Step S68 is NO, the process ends without conducting the parameter upgrading operation.

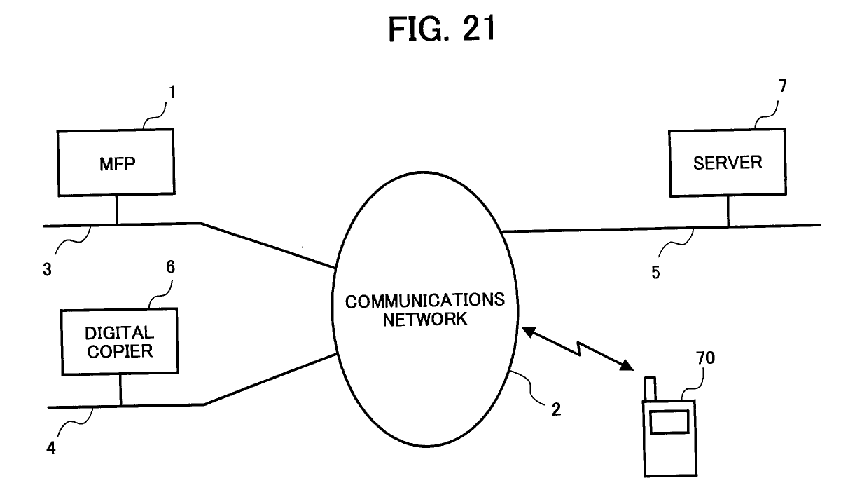

FIG. 21 shows an alternative network system similar to the network system shown in FIG. 1, except for a mobile terminal apparatus 70. This mobile terminal apparatus 70 may be a mobile cellular phone such as a PDC (personal digital cellular-phone). In the network system of FIG. 21, the MFP 1 and the digital copier 6 may communicate with the server 7 through the LANs 3 and 4, respectively, via the communications network 2 to perform the above-described function enhancement operation upon a receipt of a request for the function enhancement operation from the PC 21. In addition, this network system of FIG. 21 allows the mobile terminal apparatus 70 to send such request for the function enhancement operation to the MFP 1 or the digital copier 6.

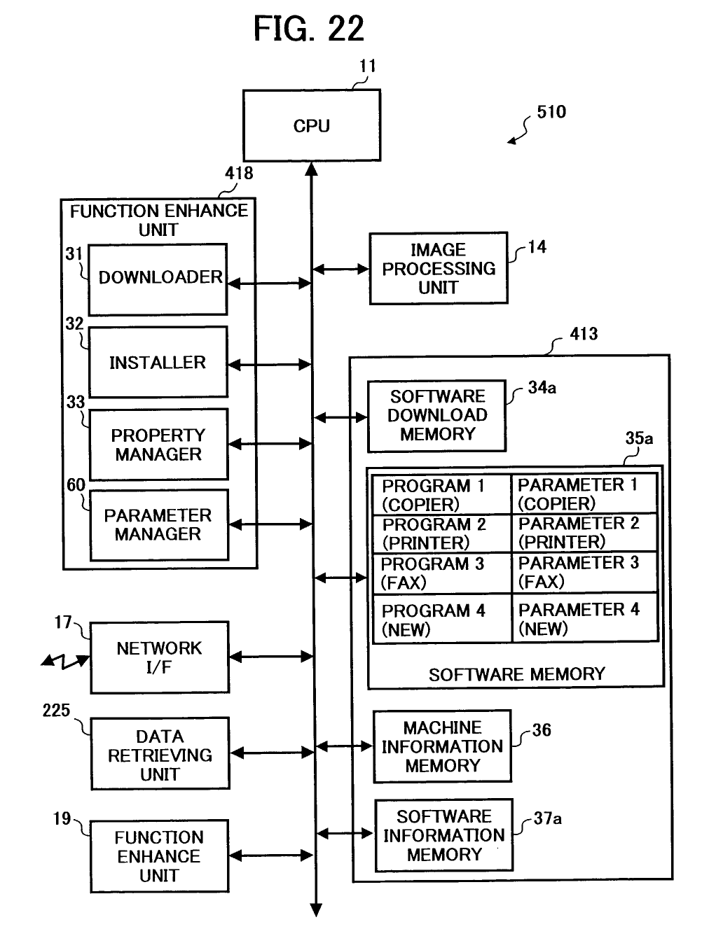

FIG. 22 shows another modified printer controller 510 which is similar to the modified printer controller 410 of FIG. 18, except for an addition of the data retrieving unit 225 for retrieving individual image processing programs or software sets from a data storing medium.

This invention may be conveniently implemented using a conventional general purpose digital computer programmed according to the teaching of the present specification, as will be apparent to those skilled in the computer art. Appropriate software coding can readily be prepared by skilled programmers based on the teachings of the present disclosure, as will be apparent to those skilled in the software art. The present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that within the scope of the appended claims, the disclosure of this patent specification may be practiced otherwise than as specifically described herein.

What is claimed is:

1. An image processing apparatus, comprising:
a memory storing a plurality of individual image processing programs;
an image processing mechanism including a plurality of hardware resources performing individual image processing operations in collaboration with the plurality of individual image processing programs;
a function enhancing mechanism configured to perform an addition of a new individual image processing program to the memory and an upgrade of an existing individual image processing program in the memory; and
an enhancement control mechanism configured to determine whether the image processing mechanism includes a hardware resource corresponding to the new individual image processing program or the existing individual image processing program when the function enhancing mechanism performs such addition or upgrade.

2. An image processing apparatus as defined in claim 1, further comprising:
a data reading mechanism configured to read an individual image processing program from a data storing medium and associated property information,
wherein the data reading mechanism first reads associated property information, the enhancement control mechanism performs the determination based on the property information, and the data reading mechanism reads a corresponding individual image processing program when the enhancement control mechanism determines that the image processing mechanism includes a hardware resource corresponding to the read individual image processing program.

3. An image processing apparatus as defined in claim 1, wherein the image processing mechanism forms a plurality of function mechanisms in collaboration with the plurality of individual image processing programs stored in the memory, wherein the plurality of function mechanisms includes at least one of:
a data compressor compressing image data;
a decompressor decompressing compressed image data;
a filtering mechanism configured to correct a frequency transfer characteristics of the image data;
an image area separation control mechanism configured to determine an image property of the image data;
a scaling mechanism configured to change at least one of a scale and a density of an image;
a gamma converting mechanism configured to convert a gray-scale;
a color converting mechanism configured to convert a display color system into a print color system; and
a halftone control mechanism configured to convert the image data to reproducible halftone image data.

4. An image processing apparatus as defined in claim 1, wherein the image processing mechanism includes a digital signal processor.

5. An image processing apparatus as defined in claim 1, further comprising:
a function selecting mechanism configured to select a group of individual image processing programs corresponding to an image processing application from among the plurality of individual image processing programs stored in the memory when the image processing application is activated.

6. A method of downloading an individual image processing program from a server through a communications network to an image processing apparatus having a plurality of individual image processing programs to perform an image processing application, comprising the steps of:
obtaining property information associated with an individual image processing program to be downloaded from the server through the communications network;
determining whether the individual image processing program to be downloaded to the image processing apparatus is operable in collaboration with image processing mechanisms provided to the image processing apparatus, based on the property information obtained by the obtaining step; and
downloading the individual image processing program from the server into a memory of the image processing apparatus when the individual image processing program to be downloaded is determined as operable by the determining step.

7. A method as defined in claim 6, wherein the property information includes information indicative of a hardware resource to be required in the image processing apparatus to collaborate with the individual image processing program to be downloaded from the server.

8. A method as defined in claim 6, further comprising the step of:
sending a notification notifying that the individual image processing program to be downloaded is not operable when the determining step so determines.

9. A method as defined in claim 6, wherein the plurality of individual image processing programs include at least two of:
a data compressing program compressing image data;
a decompressing program decompressing compressed image data;
a filtering program correcting a frequency transfer characteristics of the image data;
an image area separation control program determining an image property of the image data;
a scaling program changing at least one of a scale and a density of an image;
a gamma converting program converting a gray-scale;
a color converting program converting a display color system into a print color system; and
a halftone control program converting the image data to reproducible halftone image data.

10. A method as defined in claim 6, wherein the image processing application is one of a printing application, a copying application, a facsimile application, and a filing application.

11. A method of transferring an individual image processing program from a data storing medium to an image processing apparatus, comprising the steps of:
obtaining property information associated with an individual image processing program to be transferred from the data storing medium;
determining whether the individual image processing program to be transferred to the image processing apparatus is operable in collaboration with image processing mechanisms provided to the image processing apparatus, based on the property information obtained by the obtaining step; and
transferring the individual image processing program from the data storing medium into a memory of the image processing apparatus when the individual image processing program to be transferred is determined as operable by the determining step.

12. A method as defined in claim 11, wherein the property information includes information indicative of a hardware resource to be required in the image processing apparatus to collaborate with the individual image processing program to be transferred from the data storing medium.

13. A computer readable medium storing computer instructions for performing the steps recited in any one of claims 6-12.

14. An image processing apparatus, comprising:
a memory storing a plurality of individual image processing instruction sets;
an image processing mechanism including a plurality of hardware resources performing individual image processing operations in collaboration with the plurality of individual image processing instruction sets stored in the memory;
a function selecting mechanism configured to select a group of individual image processing instruction sets according to an image processing application being activated from among the plurality of individual image processing instruction sets stored in the memory;
a function enhancing mechanism configured to perform a function enhancing operation to add a new individual image processing instruction set to the memory and to upgrade an existing individual image processing instruction set in the memory; and
an enhancement control mechanism configured to determine whether the image processing mechanism includes a hardware resource corresponding to the new individual image processing instruction set or the existing individual image processing software set when the function enhancing mechanism performs the function enhancing operation.

15. An image processing apparatus as defined in claim 14, wherein each of the plurality of the individual image processing instruction sets include an individual image processing program and associated image processing parameters.

16. An image processing apparatus as defined in claim 15, wherein the function enhancing mechanism upgrades the image processing parameters when upgrading the corresponding image processing program.

17. An image processing apparatus as defined in claim 15, further comprising:
a parameter upgrade control mechanism configured to determine whether the function enhancing mechanism upgrades the image processing parameters when upgrading the corresponding image processing program.

18. An image processing apparatus as defined in claim 17, the parameter upgrade control mechanism determines whether the function enhancing mechanism upgrades the image processing parameters when upgrading the corresponding image processing program based on property information of the apparatus.

19. An image processing apparatus as defined in claim 15, wherein the image processing parameters to be upgraded by the function enhancing mechanism are image processing parameters inherent to the apparatus.

20. An image processing apparatus as defined in claim 14, further comprising:
a communications mechanism configured to communicate with a remote terminal apparatus through a communications network,
wherein the function enhancing mechanism performs the function enhancing operation in response to a request sent from the remote terminal apparatus via the communications mechanism.

21. An image processing apparatus as defined in claim 14, further comprising:
a communications mechanism configured to communicate with a server storing a plurality of individual image processing instruction sets, through a communications network,
wherein the function enhancing mechanism performs the function enhancing operation by downloading a desired individual image processing instruction set from the server via the communications mechanism.

22. An image processing apparatus as defined in claim 21, wherein the communications network is the Internet.

23. An image processing apparatus as defined in claim 14, further comprising:
a communications mechanism configured to communicate with a server storing a plurality of individual image processing instruction sets, through an Internet,
wherein the function enhancing mechanism performs the function enhancing operation by downloading a desired individual image processing instruction set from the server via the communications mechanism in response to a request sent from a mobile terminal apparatus through the Internet.

24. An image processing apparatus, comprising:
storing means for storing a plurality of individual image processing instruction sets;
image processing means including a plurality of hardware resources performing individual image processing operations in collaboration with the plurality of individual image processing instruction sets stored in the storing means;
function selecting means for selecting a group of individual image processing instruction sets according to an image processing application being activated from among the plurality of individual image processing instruction sets stored in the storing means;
function enhancing means for performing a function enhancing operation to add a new individual image processing instruction set to the storing means and to upgrade an existing individual image processing instruction sets in the storing means; and
enhancement controlling means for determining whether the image processing means includes a hardware resource corresponding to the new individual image processing instruction set or the existing individual image processing instruction set when the function enhancing means performs the function enhancing operation.

25. An image processing apparatus as defined in claim 24, wherein each of the plurality of the individual image processing instruction sets includes an individual image processing program and associated image processing parameters.

26. An image processing apparatus as defined in claim 25, wherein the function enhancing means upgrades the image processing parameters when upgrading the corresponding image processing program.

27. An image processing apparatus as defined in claim 25, further comprising:
parameter upgrade controlling means for determining whether the function enhancing means upgrades the image processing parameters when upgrading the corresponding image processing program.

28. An image processing apparatus as defined in claim 27, wherein the parameter upgrade control means determines whether the function enhancing means upgrades the image processing parameters when upgrading the corresponding image processing program based on property information of the apparatus.

29. An image processing apparatus as defined in claim 25, wherein the image processing parameters to be upgraded by the function enhancing means are image processing parameters inherent to the apparatus.

30. An image processing apparatus as defined in claim 24, further comprising:
communications means for communicating with a remote terminal apparatus through a communications network,
wherein the function enhancing means performs the function enhancing operation in response to a request sent from the remote terminal apparatus via the communications means.

31. An image processing apparatus as defined in claim 24, further comprising:
communications means for communicating with a server storing a plurality of individual image processing instruction sets, through a communications network,
wherein the function enhancing means performs the function enhancing operation by downloading a desired individual image processing software set from the server via the communications means.

32. An image processing apparatus as defined in claim 31, wherein the communications network is the Internet.

33. An image processing apparatus as defined in claim 24, further comprising:
communications means for communicating with a server storing a plurality of individual image processing instruction sets, through an Internet,
wherein the function enhancing means performs the function enhancing operation by downloading a desired individual image processing instruction set from the server via the communications means in response to a request sent from a mobile terminal apparatus through the Internet.

34. A method of image processing, comprising the steps of:
storing a plurality of individual image processing instruction sets, from which a group of individual image processing instruction sets is selectable according to an image processing application being activated on an image processing apparatus;
providing a plurality of hardware resources performing individual image processing operations in collaboration with the plurality of individual image processing instruction sets stored in the storing step;
performing a function enhancing operation to add a new individual image processing instruction set and to upgrade an existing individual image processing instruction set; and
determining whether the hardware resources provided in the providing step includes a hardware resource corresponding to the new individual image processing instruction set or the existing individual image processing instruction set when the performing step performs the function enhancing operation.

35. A method as defined in claim 34, wherein each of the plurality of the individual image processing instruction sets includes an individual image processing program and associated image processing parameters.

36. A method as defined in claim 35, wherein the function enhancing operation performed by the performing step upgrades the image processing parameters when upgrading the corresponding image processing program.

37. A method as defined in claim 35, further comprising the step of:
determining whether the function enhancing operation upgrades the image processing parameters when upgrading the corresponding image processing program.

38. A method as defined in claim 37, wherein the determining step determines whether the function enhancing operation upgrades the image processing parameters when upgrading the corresponding image processing program based on property information of the apparatus.

39. A method as defined in claim 35, wherein the image processing parameters to be upgraded by the function enhancing operation performed by the performing step are image processing parameters inherent to the apparatus.

40. A method as defined in claim 34, further comprising the step of:
communicating with a remote terminal apparatus through a communications network,
wherein the performing step performs the function enhancing operation in response to a request sent from the remote terminal apparatus through the communicating step.

41. A method as defined in claim 34, further comprising the step of:
communicating with a server storing a plurality of individual image processing instruction sets, through a communications network,
wherein the performing step performs the function enhancing operation by downloading a desired individual image processing instruction set from the server through the communicating step.

42. A method as defined in claim 41, wherein the communications network is the Internet.

43. A method as defined in claim 34, further comprising the step of:
communicating with a server storing a plurality of individual image processing instruction sets, through an Internet,
wherein the performing step performs the function enhancing operation by downloading a desired individual image processing instruction set from the server through the communicating step in response to a request sent from a mobile terminal apparatus through the Internet.

44. A computer readable medium storing computer instructions for performing the steps recited in anyone of claims 34-43.
